(19) United States
(12) Patent Application Publication
(10) Pub. No.: US 2026/0221680 A1
(43) Pub. Date: Jul. 30, 2026

(54) CONNECTOR HAVING TERMINAL AND PRINTED CIRCUIT BOARD INCLUDING SAME

(71) Applicant: SAMSUNG ELECTRONICS CO., LTD., Suwon-si (KR)

(72) Inventors: Inha LEE, Suwon-si (KR); Heekang YUN, Suwon-si (KR); Hanseok MUN, Suwon-si (KR); Kyungho LEE, Suwon-si (KR)

(73) Assignee: SAMSUNG ELECTRONICS CO., LTD., Suwon-si (KR)

(21) Appl. No.: 19/629,831

(22) Filed: Mar. 26, 2026

Related U.S. Application Data
(63) Continuation of application No. PCT/KR2024/011895, filed on Aug. 9, 2024.

(30) Foreign Application Priority Data
Sep. 26, 2023 (KR) 10-2023-0129636
Oct. 24, 2023 (KR) 10-2023-0143382

(51) Int. Cl. H01R 12/70; H01R 12/71; H01R 13/24; H01R 13/64

(52) U.S. Cl. CPC H01R 12/7082; H01R 12/716; H01R 13/2407; H01R 13/64

(57) ABSTRACT

A connector includes: a wall; and a terminal spaced apart from the wall and configured to be electrically connected to another connector. The terminal comprises: a contact part configured to be pressed by the another connector, in a state that the connector is connected to the another connector, and a holding part extended from the contact part. The holding part is, while the connector is connected to the another connector, configured to be contacted with the contact part that is moved in accordance with a pressure exerted by the another connector, be deformed by the contact with the contact part to press the wall, and maintain a connection between the connector and the another connector by transmitting, to the contact part, a repulsive force caused by pressing the wall.

### CROSS-REFERENCE TO RELATED APPLICATIONS

This application is a continuation of International Application No. PCT/KR2024/011895, filed on August 9, 2024, which is based on and claims priority to Korean Patent Application No. 10-2023-0129636, filed on September 26, 2023, and Korean Patent Application No. 10-2023-0143382, filed on October 24, 2023, in the Korean Ministry of Intellectual Property, the disclosures of which are incorporated by reference herein in their entireties.

### BACKGROUND

### 1. Field

The present disclosure relates to a connector having a terminal and a printed circuit board including the same.

### 2. Description of Related Art

A printed circuit board or an electronic device may include a connector connecting components mounted on the printed circuit board to a component mounted on another printed circuit board. The connector may include a socket and a plug. Connectors corresponding to each other may be combined with each other. The combined connectors may connect components to each other for power, a signal, or data transmission.

The above-described information may be provided as a related art for a purpose of helping understanding of the present disclosure. No claim or determination is raised as to whether any of the above-described descriptions may be applied as a prior art related to the present disclosure.

### SUMMARY

According to an aspect of the disclosure, a connector includes: a wall; and a terminal spaced apart from the wall and configured to be electrically connected to another connector. The terminal includes: a contact part configured to be pressed by the another connector, in a state that the connector is connected to the another connector, and a holding part extended from the contact part. The holding part is, while the connector is connected to the another connector, configured to be contacted with the contact part that is moved in accordance with a pressure exerted by the another connector, be deformed by the contact with the contact part to press the wall, and maintain a connection between the connector and the another connector by transmitting, to the contact part, a repulsive force caused by pressing the wall.

According to an aspect of the disclosure, a printed circuit board includes: a substrate; and a connector mounted on the substrate, the connector comprising a fixed wall and a movable terminal having elasticity. The movable terminal comprises: a contact part configured to contact a terminal of another connector, in a state that the connector is connected to the another connector, and a holding part extended from the contact part toward the substrate along the wall. The contact part comprises: an extension area connected to the holding part, a contact area connected to the extension area and configured to move toward the wall in contact with another terminal of the another connector, while the connector is connected to the another connector, and a pressing area extended from the contact area to the holding part, the pressing area contacting a surface of the holding part facing the contact part as the contact area moves. The holding part is configured to, while the connector is connected to the another connector, be deformed by the contact with the contact part to press the wall and maintain a connection between the connector and the another connector by transmitting, to the contact part, a repulsive force caused by pressing the wall.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view representing an example connector according to an embodiment;

FIG. 2 is a perspective view representing an example first connector according to an embodiment;

FIG. 3 is a perspective view representing an example second connector according to an embodiment;

FIG. 4 is an example cross-sectional view in which combined connectors are cut along line A-A′;

FIG. 5 is an example cross-sectional view in which a first connector is cut along line B-B′;

FIG. 6A is a diagram representing an example movable terminal of a first connector according to an embodiment;

FIG. 6B is a diagram representing a change in a movable terminal of a first connector when a second connector is combined with the first connector according to an embodiment;

FIG. 7 is an enlarged view of an area C of a first connector;

FIG. 8 is a diagram illustrating a movable terminal of a first connector including a protruding part therein according to an embodiment;

FIG. 9 is a diagram illustrating a movable terminal of a first connector including a groove therein according to an embodiment; and

FIG. 10 is a block diagram of an electronic device in a network environment according to various embodiments.

### DETAILED DESCRIPTION

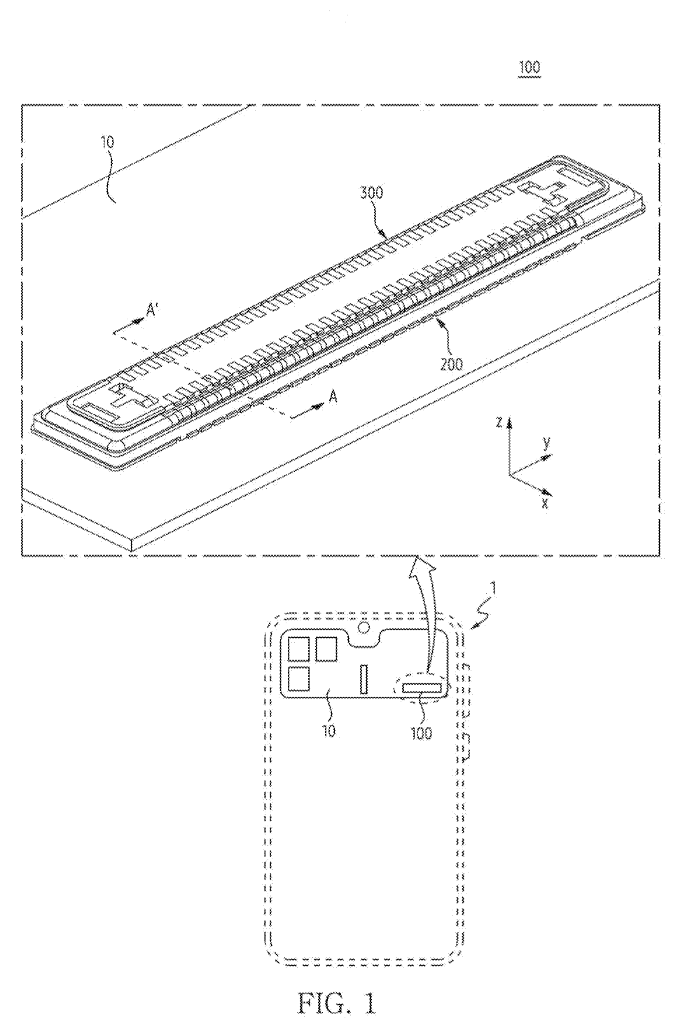

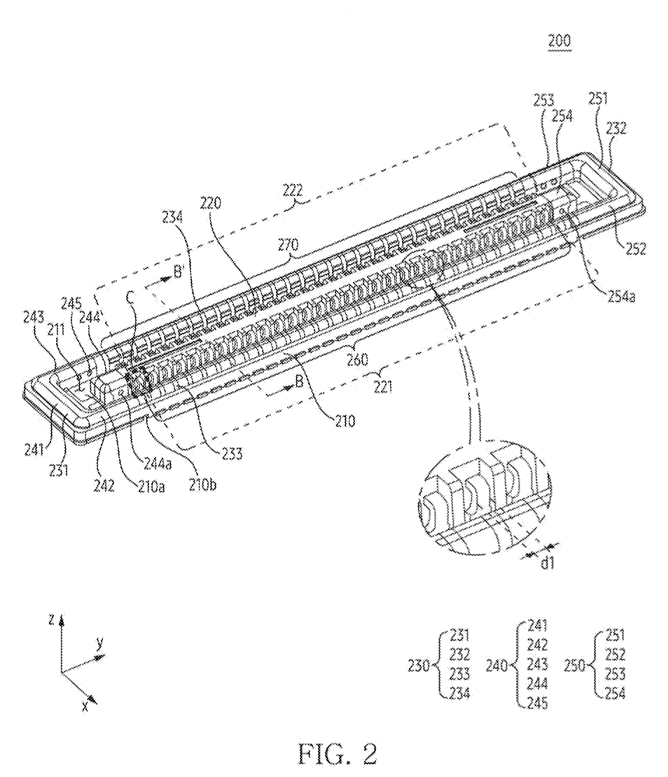

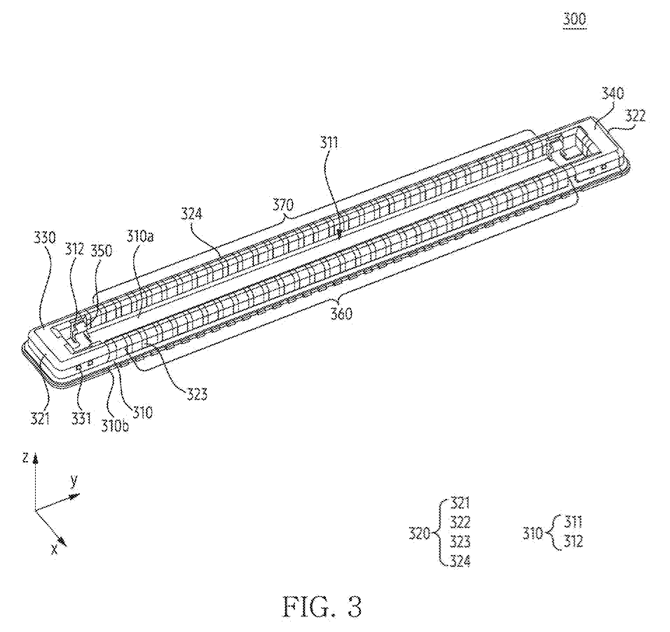

FIG. 1 is a perspective view representing an example connector. FIG. 2 is a perspective view representing an example first connector. FIG. 3 is a perspective view representing a second connector according to an embodiment.

A pair of connectors 100 mounted on an electronic device 1 may electrically connect components in the electronic device 1. An internal component of the electronic device 1 connected to a printed circuit board 10 by the pair of connectors 100 may be replaced by detachable connectors. A connector (e.g., a first connector 200 or a second connector 300) of the pair of connectors 100 may be mounted on a substrate of the printed circuit board 10. For example, the connector may be a board to board (BtoB) connector connecting different boards.

The board to board connector may include the first connector 200 (e.g., a plug connector, a header connector, or a male connector) and the second connector 300 (e.g., a socket connector, a receptacle connector, or a female connector) detachably combined with the first connector 200. The first connector 200 and the second connector 300 may form an electrical connection between internal components of the electronic device 1 for power supply or data signal transmission by being combined with each other.

The electronic device 1 may be miniaturized for user portability. As the electronic device 1 is miniaturized, the pair of connectors 100 electrically connecting internal components and internal components of the electronic device 1 may also be miniaturized. Since a width of terminals of the connectors 100 is narrowed, it may be difficult to secure contact pressure for maintaining an electrical connection of the connectors 100. Hereinafter, a structure for maintaining the connection between the pair of miniaturized connectors 100 will be described in detail based on the drawings.

Referring to FIGS. 1, 2, and 3, the electronic device 1 may include the printed circuit board 10. The printed circuit board 10 may be disposed inside the electronic device 1 (e.g., inside a housing). The printed circuit board 10 may include the connectors 100 disposed on a surface of the substrate configuring the printed circuit board 10. The pair of connectors 100 may include the first connector 200 and the second connector 300. The pair of connectors 100 may electrically connect an internal component of the electronic device 1. For example, as a connector (e.g., the first connector 200) disposed on the printed circuit board 10 is fastened to another connector (e.g., the second connector 300) disposed at an end portion of a line electrically connected to the internal component of the electronic device 1, the pair of connectors 100 may electrically connect the component of the electronic device 1 and the printed circuit board 10. For example, the pair of connectors 100 may transmit an electrical signal for an operation of a display, a camera, and/or a battery. The pair of connectors 100 may electrically connect a printed circuit board and another printed circuit board. The pair of connectors 100 may be referred to as a pair of connecting members in terms of providing a connection between a component and a printed circuit board or between printed circuit boards.

At least one of the connectors configuring the pair of connectors 100 may be fixed (or mounted) on a printed circuit board by a surface mounted technology (SMT) process. A connector configuring the pair of connectors 100 may be fixed on a printed circuit board by soldering. For example, the first connector 200 configuring the pair of connectors 100 may be electrically connected to a printed circuit board by soldering to the printed circuit board. According to an embodiment, the first connector 200 and the second connector 300 may be a plug (or a header or a male) and a socket (or a receptacle or a female) in a board to board connector (a BtoB connector) connecting different boards. The first connector 200 and the second connector 300 may be disposed on different printed circuit boards and may provide a path for a signal for power supply or a signal for data transmission. For example, the first connector 200 may be disposed on a printed circuit board, and the second connector 300 may be disposed on a flexible printed circuit board (FPCB). However, embodiments are not limited thereto, the first connector 200 may be disposed on a printed circuit board, the second connector 300 may be disposed on another printed circuit board, and the pair of connectors 100 may be a BtoB connector connecting printed circuit boards.

The first connector 200 may be a socket connector soldered on the printed circuit board, and the second connector 300 may be a plug connector connected to an end of the FPCB. Another end of the FPCB may be connected to another printed circuit board or another component distinguished from the printed circuit board. The another end of the FPCB may include the same or similar plug connector as the second connector 300, and the plug connector positioned at the another end of the FPCB may be fastened to a socket connector disposed on the another printed circuit board or the another component. For another example, the another end of the FPCB may be integrally formed with lines extended from the another printed circuit board or the another component instead of a connector being disposed. As the first connector 200 and the second connector 300 are fastened to each other, the pair of connectors 100 may electrically connect a printed circuit board and another printed circuit board or a printed circuit board and another component.

The first connector 200 may include a base 210, a wall 220, side walls 230, conductive members 240 and 250, and a set 260 or 270 of a plurality of signal terminals.

The base 210, the wall 220, and the side walls 230 may form an outer shape of the first connector 200. The base 210, the wall 220, and the side walls 230 may be integrally formed. The base 210, the wall 220, and the side walls 230 may include a non-conductive material. For example, the base 210, the wall 220, and the side walls 230 may be a polymer material having rigidity. For example, the base 210, the wall 220, and the side walls 230 may be manufactured as an insulator including resin and/or epoxy, which are a non-conductive material, but are not limited thereto. The base 210, the wall 220, and the side walls 230, which are integrally formed, may be referred to as a housing or a body in terms of forming the outer shape of the first connector 200. The wall 220 and the side walls 230 may be referred to as a non-conductive side wall in terms of providing a space capable of accommodating the second connector 300 by being formed of a non-conductive material.

According to an embodiment, when the first connector 200 and the second connector 300 are combined, a surface 210a of the base 210 mounted on the printed circuit board 10 may face the second connector 300, and another surface 210b facing the surface 210a may face the printed circuit board 10 of the electronic device 1. For example, the another surface 210b of the base 210 may be disposed on the printed circuit board 10. The first connector 200 may include a conductive material exposed to the another surface 210b. The conductive material exposed to the another surface 210b of the first connector 200 may be soldered with a conductive material exposed to the printed circuit board 10. By the combination of the conductive materials, the first connector 200 may be electrically connected to the printed circuit board 10. According to an embodiment, the base 210 may include a recess 211. The recess 211 may be an empty space formed on a surface 210a of the base 210 and accommodating at least a portion of the second connector 300. For example, the recess 211 may have a shape corresponding to a shape of the second connector 300. As a portion of the second connector 300 is accommodated into the empty space of the recess 211, the first connector 200 and the second connector 300 may be fastened.

According to an embodiment, the wall 220 may guide a fastening position of the second connector 300 when the first connector 200 and the second connector 300 are fastened. The wall 220 may be formed in a shape corresponding to an accommodation space 311 of the second connector 300. For example, when the first connector 200 and the second connector 300 are combined, the wall 220 may occupy the accommodation space 311 of the second connector 300.

According to an embodiment, the wall 220 may be a portion of the base 210 surrounded by the recess 211. According to an embodiment, the wall 220 may protrude from the surface 210a of the base 210. For example, the wall 220 may have a shape that protrudes from a center of the surface 210a of the base 210 and be extended long along a direction. The wall 220 may be extended along a longitudinal direction (e.g., a y-axis direction) of the base 210. The wall 220 may be spaced apart from the side walls 230 formed in the base 210.

According to an embodiment, the side walls 230 may be a portion in which terminals for transmitting a signal and power are disposed when the first connector 200 and the second connector 300 are combined. The side walls 230 may be disposed on the surface 210a of the base 210 and may form the recess 211. According to an embodiment, the side walls 230 may surround the wall 220. For example, the side walls 230 may form the recess 211 together with the wall 220. The side walls 230 may provide the recess 211 between the side walls 230 and the wall 220 by being spaced apart from the wall 220. According to an embodiment, the side walls 230 may include a first side wall 231, a second side wall 232, a third side wall 233, and a fourth side wall 234. The first side wall 231 may be extended along a first direction (e.g., a -x direction). The second side wall 232 may be extended substantially parallel to the first side wall 231. For example, the second side wall 232 may be spaced apart from the first side wall 231 along a second direction (e.g., a +y direction) substantially perpendicular to the first direction and may be extended in the first direction (e.g., the -x direction). The third side wall 233 may be extended from an end of the first side wall 231 to an end of the second side wall 232 in the second direction (e.g., the +y direction). The fourth side wall 234 may be extended from another end of the first side wall 231 to another end of the second side wall 232 in the second direction. According to an embodiment, the third side wall 233 may be spaced apart from the fourth side wall 234 along the first direction (e.g., the -x direction) and may be extended substantially parallel to the fourth side wall 234.

According to an embodiment, the side walls 230 may include a corner formed at a position where one side wall of the side walls 230 is in contact with another side wall. For example, the corner may be formed at a position where the first side wall 231 and the third side wall 233 are in contact, a position where the first side wall 231 and the fourth side wall 234 are in contact, a position where the second side wall 232 and the third side wall 233 are in contact, and a position where the second side wall 232 and the fourth side wall 234 are in contact. According to an embodiment, an angle of the corner may be changed according to an angle at which each of the side walls 230 is in contact. For example, the angle of the corner may be a right angle, as each of the side walls 230 is in contact so as to be orthogonal to each other. For another example, the corner may have a curvature, as at least one of the side walls 230 is bent in an area adjacent to the corner.

According to an embodiment, the conductive members 240 and 250 may be a power terminal of the first connector 200 that inputs or outputs power. The conductive members 240 and 250 may function as a reinforcing member for preventing damage to the first connector 200 while serving as the power terminal of the first connector 200. For example, the conductive members 240 and 250 may be manufactured as a material with better rigidity than the base 210 to prevent the base 210 and the wall 220 from being damaged by the second connector 300 when the first connector 200 and the second connector 300 are combined. For example, the conductive members 240 and 250 may be manufactured as a metal material including copper, and the like, with excellent electrical conductivity, but are not limited thereto. According to an embodiment, the conductive members 240 and 250 may include a first conductive member 240 and a second conductive member 250. The first conductive member 240 may be disposed at a periphery of the first connector 200. The second conductive member 250 may be disposed at another periphery of the first connector 200, which is opposite to the periphery of the first connector 200 at which the first conductive member 240 is disposed. According to an embodiment, the first conductive member 240 and the second conductive member 250 may function as electrode terminals having opposite polarities. For example, in a case that the first conductive member 240 functions as a positive electrode terminal, the second conductive member 250 may function as a negative electrode terminal.

According to an embodiment, the first conductive member 240 may include a first reinforcing part 241, a second reinforcing part 242, a third reinforcing part 243, and a first contact part 244. According to an embodiment, the first conductive member 240 may integrally form the first reinforcing part 241, the second reinforcing part 242, the third reinforcing part 243, and the first contact part 244.

According to an embodiment, the first reinforcing part 241 may cover at least a portion of the first side wall 231. For example, the first reinforcing part 241 may cover an outer surface of the first side wall 231 and may be extended along the first direction (e.g., the -x direction) from an end of the first side wall 231 to another end of the first side wall 231. According to an embodiment, a portion of the first reinforcing part 241 may cover a portion (e.g., a portion of the recess 211) of the surface 210a of the base 210. The first reinforcing part 241 may cover a portion of the recess 211 in contact with the first side wall 231. A portion of the first reinforcing part 241 positioned on the surface 210a of the base 210 may prevent the surface 210a of the base 210 from being damaged by the second connector 300.

According to an embodiment, the second reinforcing part 242 may cover an area including a corner where the first side wall 231 and the third side wall 233 are in contact. For example, the second reinforcing part 242 may cover a portion of the third side wall 233 from the corner formed by the first side wall 231 and the third side wall 233 and extend in the second direction (e.g., the +y direction).

According to an embodiment, the third reinforcing part 243 may cover an area including a periphery where the first side wall 231 and the fourth side wall 234 are in contact. For example, the third reinforcing part 243 may cover a portion of the fourth side wall 234 from the corner formed by the first side wall 231 and the fourth side wall 234 and extend in the second direction (e.g., the +y direction).

According to an embodiment, the first reinforcing part 241, the second reinforcing part 242, and the third reinforcing part 243 may be integrally formed. The first reinforcing part 241, the second reinforcing part 242, and the third reinforcing part 243 may prevent the first side wall 231 from being exposed to the outside. The first reinforcing part 241, the second reinforcing part 242, and the third reinforcing part 243 may prevent the corner of the side walls 230 at which the first side wall 231 and the third side wall 233 are in contact and the corner of the first side wall 231 and the fourth side wall 234 are in contact, from being exposed to the outside.

According to an embodiment, the first contact part 244 may be electrically connected to a terminal of the second connector 300 when the first connector 200 and the second connector 300 are combined. According to an embodiment, the first contact part 244 may be disposed to cover an end portion of the wall 220. The first contact part 244 may prevent the wall 220 from being damaged by the second connector 300 when the first connector 200 and the second connector 300 are combined. For example, the first contact part 244 may cover each of side surfaces of the end portion of the wall 220 facing the first reinforcing part 241, the second reinforcing part 242, and the third reinforcing part 243. According to an embodiment, the first contact part 244 may include a terminal groove 244a electrically connected to a movable terminal of the second connector 300 when the first connector 200 and the second connector 300 are combined. When the first connector 200 and the second connector 300 are combined, the terminal groove 244a may form an electric contact by being in contact with a terminal 350 of the second connector 300. The terminal groove 244a may be formed, for example, on a side surface of the first contact part 244 facing the second reinforcing part 242 or a side surface of the first contact part 244 facing the third reinforcing part 243.

According to an embodiment, the first conductive member 240 may include a contact groove 245. When the first connector 200 and the second connector 300 are combined, the contact groove 245 may form an electric contact by being in contact with an outer side surface of the second connector 300. For example, the contact groove 245 may be formed on a side surface of the second reinforcing part 242 facing the wall 220 in the first direction (e.g., the -x direction). For another example, the contact groove 245 may be formed on a side surface of the third reinforcing part 243 facing the wall 220 in a direction (e.g., the +x direction) opposite to the first direction.

According to an embodiment, as the first conductive member 240 integrally forms the first reinforcing part 241, the second reinforcing part 242, and the third reinforcing part 243, it may increase a contact extent of the conductive member when the first connector 200 is combined with the second connector 300. The first reinforcing part 241, the second reinforcing part 242, and the third reinforcing part 243 may secure a large contact extent with the second connector 300 by fully covering the first side wall 231, the corners formed at both ends of the first side wall 231, a portion of the third side wall 233, and a portion of the fourth side wall 234. The pair of connectors 100 may increase an amount of current that may flow between the first connector 200 and the second connector 300.

According to an embodiment, the second conductive member 250 may be disposed at a periphery of the first connector 200 so as to be symmetrical to the first conductive member 240 with respect to the wall 220. Since the second conductive member 250 and the first conductive member 240 may be equal or similar to each other, the above-described description of the first conductive member 240 may also be applied equally or similarly to the second conductive member 250. For example, the second conductive member 250 may include a fourth reinforcing part 251, a fifth reinforcing part 252, a sixth reinforcing part 253, and a second contact part 254. The second conductive member 250 may integrally form the fourth reinforcing part 251, the fifth reinforcing part 252, the sixth reinforcing part 253, and the second contact part 254. The fourth reinforcing part 251 may cover the second side wall 232. The fifth reinforcing part 252 may cover an area including a corner where the second side wall 232 and the third side wall 233 are in contact. The sixth reinforcing part 253 may cover an area including a corner where the second side wall 232 and the fourth side wall 234 are in contact. The second contact part 254 may be disposed to cover another end portion of the wall 220, which is opposite to an end portion of the wall 220. The second contact part 254 may include a terminal groove 254a accommodating a portion of the terminal 350 of the second connector 300 when combined with the second connector 300.

According to an embodiment, similarly to the first conductive member 240, the fourth reinforcing part 251, the fifth reinforcing part 252, and the sixth reinforcing part 253 may secure a large contact extent with the second connector 300 by fully covering the second side wall 232, the corners formed at both ends of the second side wall 232, a portion of the third side wall 233, and a portion of the fourth side wall 234. The pair of connectors 100 may increase an amount of current that may flow between the first connector 200 and the second connector 300.

The set 260 or 270 of the plurality of signal terminals may be connected to a data line. The set 260 or 270 of the plurality of signal terminals may input or output an electrical signal for data exchange between internal components of the electronic device 1. The set 260 or 270 of the plurality of signal terminals may be disposed to be spaced apart from each other. According to an embodiment, each of signal terminals of the set 260 or 270 of the plurality of signal terminals may input or output different types of electrical signals. The set 260 or 270 of the plurality of signal terminals may include a conductive member. The set 260 or 270 of the plurality of signal terminals may be manufactured as a metal material including copper, silver, or gold with excellent electrical conductivity, but is not limited thereto. The set 260 or 270 of the plurality of signal terminals may be referred to as a movable terminal or an elastic terminal in terms of having elastic and being deformable by an external force.

According to an embodiment, the set 260 or 270 of the plurality of signal terminals may include a set 260 of a plurality of first signal terminals and a set 270 of a plurality of second signal terminals. The set 260 of the plurality of first signal terminals may be spaced apart from the third side wall 233 and spaced apart from each other along a parallel direction (e.g., a +y-axis direction) of the third side wall 233. The set 270 of the plurality of second signal terminals may be spaced apart from the fourth side wall 234 and spaced apart from each other along a parallel direction (e.g., the +y-axis direction) of the fourth side wall 234. The set 260 of the plurality of first signal terminals and the set 270 of the plurality of second signal terminals may be disposed in the wall 220. In order to minimize a size of the first connector 200, a width d1 of each of the signal terminals configuring the set 260 or 270 of the plurality of signal terminals may be approximately 0.3 mm or less. For example, the width d1 of each of the signal terminals configuring the set 260 or 270 of the plurality of signal terminals may be 0.15 mm to 0.3 mm. The pair of connectors 100 having a reduced size may increase efficiency of a space of the electronic device 1.

According to an embodiment, the wall 220 may include a plurality of accommodation grooves 221 and 222. The plurality of accommodation grooves 221 and 222 may accommodate the set 260 or 270 of the plurality of signal terminals, respectively. According to an embodiment, the plurality of accommodation grooves 221 and 222 may include a plurality of first accommodation grooves 221 and a plurality of second accommodation grooves 222. The plurality of first accommodation grooves 221 may be formed on a side surface of the wall 220 facing the third side wall 233 to accommodate the set 260 of the plurality of first signal terminals. The plurality of second accommodation grooves 222 may be formed on another side surface of the wall 220 facing the fourth side wall 234 to accommodate the set 270 of the plurality of second signal terminals. For example, the plurality of first accommodation grooves 221 may be disposed at a position of the side surface of the wall 220 corresponding to a position of the third side wall 233 where the set 260 of the plurality of first signal terminals is disposed. The plurality of second accommodation grooves 222 may be disposed at a position of the another side surface of the wall 220 corresponding to a position of the fourth side wall 234 where the set 270 of the plurality of second signal terminals is disposed.

According to an embodiment, the second connector 300 may include a mold 310, partition walls 320, metallic members 330 and 340, the terminal 350, and a plurality of signal terminals 360 and 370.

According to an embodiment, the mold 310 may be disposed on a printed circuit board different from the printed circuit board 10 on which the first connector 200 is disposed. According to an embodiment, when the first connector 200 and the second connector 300 are combined, a surface 310a of the mold 310 may face the first connector 200, and another surface 310b facing the surface 310a may face another printed circuit board of the electronic device 1 that is distinct from the printed circuit board 10 combined with the first connector 200. For example, the mold 310 may be manufactured as an insulator, including resin, epoxy, and the like, which are a non-conductive material, but is not limited thereto. According to an embodiment, the accommodation space 311 may be formed in the mold 310. The accommodation space 311 may accommodate the wall 220 of the first connector 200 when the first connector 200 and the second connector 300 are combined. According to an embodiment, the another printed circuit board connected to the second connector 300 may be a flexible printed circuit board. For example, the flexible printed circuit board may be formed to connect printed circuit boards, and connectors may be attached to both ends thereof.

According to an embodiment, the partition walls 320 may be disposed on the surface 310a of the mold 310 and may form the accommodation space 311. The partition walls 320 may surround the wall 220 of the first connector 200 when the first connector 200 and the second connector 300 are combined. According to an embodiment, the partition walls 320 may include a first partition wall 321, a second partition wall 322, a third partition wall 323, and a fourth partition wall 324. The first partition wall 321 may be extended along the first direction (e.g., the -x direction). The second partition wall 322 may be extended substantially parallel to the first partition wall 321. For example, the second partition wall 322 may be spaced apart from the first partition wall 321 along the second direction (e.g., the +y direction) substantially perpendicular to the first direction and may be extended in the first direction. The third partition wall 323 may be extended from an end of the first partition wall 321 to an end of the second partition wall 322 in the second direction. The fourth partition wall 324 may be extended from another end of the first partition wall 321 to another end of the second partition wall 322 in the second direction. For example, the fourth partition wall 324 may be spaced apart from the third partition wall 323 along the first direction and be extended substantially parallel to the third partition wall 323.

According to an embodiment, when the first connector 200 and the second connector 300 are combined, the partition walls 320 of the second connector 300 may be in contact with the side walls 230 of the first connector 200. For example, when the first connector 200 and the second connector 300 are combined, the first partition wall 321 may be in contact with the first side wall 231, the second partition wall 322 may be in contact with the second side wall 232, the third partition wall 323 may be in contact with the fourth side wall 234, and the fourth partition wall 324 may be in contact with the third side wall 233.

According to an embodiment, the partition walls 320 may include a corner formed at a position where one partition wall of the partition walls 320 and another partition wall are in contact with each other. For example, the corner may be formed at a position where the first partition wall 321 and the third partition wall 323 are in contact, a position where the first partition wall 321 and the fourth partition wall 324 are in contact, a position where the second partition wall 322 and the third partition wall 323 are in contact, and a position where the second partition wall 322 and the fourth partition wall 324 are in contact.

According to an embodiment, the partition walls 320 may occupy the recess 211 of the first connector 200 when the first connector 200 and the second connector 300 are fastened. For example, the partition walls 320 may protrude in a shape corresponding to a shape of the recess 211.

According to an embodiment, the metallic members 330 and 340 may function as a power terminal of the second connector 300 by inputting or outputting an electrical signal for supplying power. According to an embodiment, the metallic members 330 and 340 may be in contact with the conductive members 240 and 250 of the first connector 200 when the first connector 200 and the second connector 300 are combined. According to an embodiment, the metallic members 330 and 340 may include a first metallic member 330 and a second metallic member 340. The first metallic member 330 may be disposed at a periphery of the second connector 300. The second metallic member 340 may be spaced apart from the first metallic member 330 and disposed at another periphery of the second connector 300. According to an embodiment, when the first connector 200 and the second connector 300 are combined, the first metallic member 330 of the second connector 300 may be in contact with the first conductive member 240 of the first connector 200, and the second metallic member 340 of the second connector 300 may be in contact with the second conductive member 250 of the first connector 200.

According to an embodiment, the first metallic member 330 and the second metallic member 340 may function as electrode terminals having opposite polarities. For example, in a case that the first metallic member 330 functions as a positive electrode terminal, the second metallic member 340 may function as a negative electrode terminal. For example, the metallic members 330 and 340 may be manufactured as a metal material including copper, and the like, with excellent electrical conductivity, but are not limited thereto.

According to an embodiment, the first metallic member 330 may cover an area including a corner in which one partition wall of the partition walls 320 and another partition wall are in contact. For example, the first metallic member 330 may cover an area including a corner where the first partition wall 321 and the third partition wall 323 are in contact and an area including a corner where the first partition wall 321 and the fourth partition wall 324 are in contact. According to an embodiment, the first metallic member 330 may include a contact protrusion 331. When the first connector 200 and the second connector 300 are combined, the contact protrusion 331 may form an electric contact by being in contact with a contact groove 245 of the first conductive member 240. According to an embodiment, the contact protrusion 331 may protrude from an outer side surface of the first metallic member 330.

According to an embodiment, the second metallic member 340 may be disposed at a periphery of the second connector 300 so as to be symmetrical to the first metallic member 330 with respect to the accommodation space 311. Since the second metallic member 340 and the first metallic member 330 may be equal or similar to each other, the above-described description of the first metallic member 330 may also be applied equally or similarly to the second metallic member 340. For example, the second metallic member 340 may cover an area including a corner where the second partition wall 322 and the third partition wall 323 are in contact and an area including a corner where the second partition wall 322 and the fourth partition wall 324 are in contact.

According to an embodiment, the terminal 350 may be disposed on the mold 310, and may form an electrical connection with the conductive members 240 and 250 of the first connector 200 when the first connector 200 and the second connector 300 are combined. According to an embodiment, the terminal 350 may be manufactured as a deformable material and be deformed by the contact parts 244 and 254 when the first connector 200 and the second connector 300 are combined. For example, when the first connector 200 and the second connector 300 are combined, the terminal 350 may form an electrical connection with the first contact part 244 by being seated in the terminal groove 244a of the first contact part 244.

The mold 310 according to an embodiment may further include an accommodation part 312 accommodating a portion of the terminal 350. The accommodation part 312 may surround the terminal 350 by being disposed in an area of the partition walls 320 adjacent to the metallic members 330 and 340. The accommodation part 312 may provide a space in which the terminal 350 may move when the first connector 200 and the second connector 300 are combined. For example, the accommodation part 312 may be formed, adjacent to the first metallic member 330, in the third partition wall 323 and the fourth partition wall 324. For another example, the accommodation part 312 may be formed, adjacent to the second metallic member 340, in the third partition wall 323 and the fourth partition wall 324.

According to an embodiment, the plurality of signal terminals 360 and 370 may form an electrical connection with the set 260 or 270 of the plurality of signal terminals when the first connector 200 and the second connector 300 are combined. The plurality of signal terminals 360 and 370 may input or output an electrical signal for data exchange between internal components of the electronic device 1. The plurality of signal terminals 360 and 370 may be spaced apart from each other. According to an embodiment, each of signal terminals of the plurality of signal terminals 360 and 370 may input or output different types of electrical signals. For example, the plurality of signal terminals 360 and 370 may be manufactured as a metal material including copper, and the like, with excellent electrical conductivity, but are not limited thereto. According to an embodiment, the plurality of signal terminals 360 and 370 may include a set 360 of a plurality of third signal terminals and a set 370 of a plurality of fourth signal terminals. The set 360 of the plurality of third signal terminals may be spaced apart from the first metallic member 330 and spaced apart from each other along the third partition wall 323. The set 370 of the plurality of fourth signal terminals may be spaced apart from the second metallic member 340 and spaced apart from each other along the fourth partition wall 324. According to an embodiment, the set 360 of the plurality of third signal terminals and the set 370 of the plurality of fourth signal terminals may form an electrical connection with the set 260 of the plurality of first signal terminals and the set 270 of the plurality of second signal terminals, respectively, when the first connector 200 and the second connector 300 are combined.

In the pair of connectors 100 according to the above-described embodiment, rigidity may be increased as the first connector 200 includes the conductive members 240 and 250 and the second connector 300 includes the metallic members 330 and 340. For example, the first conductive member 240 may reinforce rigidity of the first connector 200 by being disposed to cover an area including a corner formed by the side walls 230. When the first connector 200 and the second connector 300 are combined, the second connector 300 may press the side walls 230 of the first connector 200. Stress may be generated inside the side walls 230 by a force pressed by the second connector 300. The stress may be concentrated on the corner formed by the side walls 230. In a case that the first conductive member 240 does not cover the corner formed by the side walls 230, the side walls 230 is damaged by stress, and thus a life of the first connector 200 may be reduced. In the first connector 200 according to an embodiment, as the first conductive member 240 is disposed to cover the corner formed by the side walls 230, the rigidity of the first connector 200 may be reinforced, thereby increasing the life.

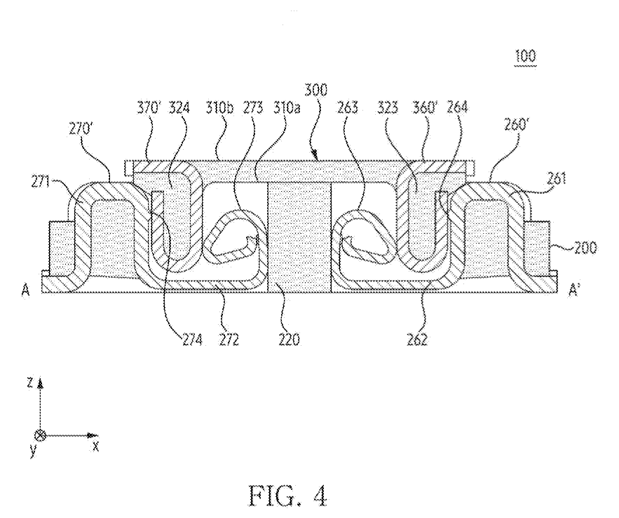

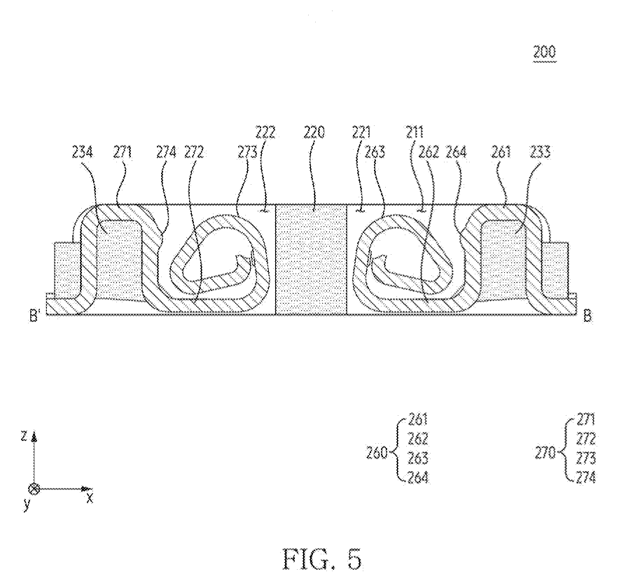

FIG. 4 is a cross-sectional view in which combined connectors are cut along line A-A′. FIG. 5 is a cross-sectional view in which a first connector is cut along line B-B′.

Referring to FIGS. 4 and 5, a first connector 200 may include a set 260 of a plurality of first signal terminals and a set 270 of a plurality of second signal terminals. A signal terminal 260′ of the set 260 of the plurality of first signal terminals may include a first fastening part 261, a first extension part 262, and a first movable part 263. The first fastening part 261 of the signal terminal 260′ of the set 260 of the plurality of first signal terminals may be disposed on a third side wall 233.

According to an embodiment, the first movable part 263 may be connected to the first extension part 262 and spaced apart from the first fastening part 261. For example, the first movable part 263 may be extended an upward direction (e.g., a +z-axis direction) from an end of the first extension part 262 adjacent to a wall 220. The first movable part 263 may be bent and spirally wound toward the first fastening part 261. The first movable part 263 may be accommodated in one of a plurality of first accommodation grooves 221. According to an embodiment, the signal terminal 260′ of the set 260 of the plurality of first signal terminals may further include a first fastening protrusion 264. The first fastening protrusion 264 may protrude from the first fastening part 261 toward the wall 220. For example, the first fastening protrusion 264 may protrude from a surface of the first fastening part 261 in a first direction (e.g., a -x-axis direction). However, embodiments are not limited thereto, and a position of the first fastening protrusion 264 may be formed at various positions. For example, the first fastening protrusion 264 may be formed in a portion of the first movable part 263, the portion of the first movable part 263 being in contact with a signal terminal 360′ of a set 360 of a plurality of third signal terminals.

A signal terminal 270′ of the set 270 of the plurality of second signal terminals may include a second fastening part 271, a second extension part 272, and a second movable part 273. The second fastening part 271 of the signal terminal 270′ of the set 270 of the plurality of second signal terminals may be disposed on a fourth side wall 234.

According to an embodiment, the second movable part 273 may be connected to the second extension part 272 and disposed to face the second fastening part 271. For example, the second movable part 273 may be extended an upward direction (the +z-axis direction) from an end of the second extension part 272 adjacent to the wall 220. The second movable part 273 may be bent and spirally wound toward the second fastening part 271. The second movable part 273 may be accommodated in one of a plurality of second accommodation grooves 222. According to an embodiment, the set 270 of the plurality of second signal terminals may include a second fastening protrusion 274. The second fastening protrusion 274 may protrude from the second fastening part 271 toward the wall 220. For example, the second fastening protrusion 274 may protrude from a surface of the second fastening part 271 in a direction (a +x-axis direction) opposite to the first direction. However, embodiments are not limited thereto, and a position of the second fastening protrusion 274 may be formed at various positions. For example, the second fastening protrusion 274 may be formed in a portion of the second movable part 273, the portion of the second movable part 273 being in contact with a signal terminal 370′ of a set 370 of a plurality of fourth signal terminals.

A second connector 300 may be fastened to the first connector 200 by at least a portion of the second connector 300 inserted into a recess 211. For example, when the first connector 200 and the second connector 300 are fastened, partition walls 323 and 324 may occupy the recess 211 of the first connector 200.

The second connector 300 may include the set 360 of the plurality of third signal terminals and the set 370 of the plurality of fourth signal terminals. The second connector 300 may further include the partition walls 323 and 324 for maintaining a shape of the set 360 of the plurality of third signal terminals and the set 370 of the plurality of fourth signal terminals. The partition walls 323 and 324 may protrude from a surface 310a of a mold 310 toward the recess 211 of the first connector 200. Another surface 310b of the mold 310 may be formed in a substantially flat surface to be disposed on a printed circuit board or an FPCB. The signal terminal 360′ of the set 360 of the plurality of third signal terminals may cover the third partition wall 323. When the first connector 200 and the second connector 300 are combined, the signal terminal 360′ covering the third partition wall 323 may be in contact with the first movable part 263. Through the signal terminal 360′ in contact with the first movable part 263, the signal terminal 360′ of the set 360 of the plurality of third signal terminals may be electrically connected to the signal terminal 260′ of the set 260 of the plurality of first signal terminals. The signal terminal 360′ of the set 360 of the plurality of third signal terminals may press the signal terminal 260′ of the set 260 of the plurality of first signal terminals. The first movable part 263 of the pressed signal terminal 260′ of the set 260 of the plurality of first signal terminals may be deformed.

The set 260 of the plurality of first signal terminals and the set 270 of the plurality of second signal terminals of the first connector 200 may be symmetrical to each other with respect to the wall 220, and the set 360 of the plurality of third signal terminals and the set 370 of the plurality of fourth signal terminals of the second connector 300 may be symmetrical to each other with respect to an accommodation space 311. It is described that the signal terminal 360′ of the set 360 of the plurality of third signal terminals is in contact with the signal terminal 260′ of the set 260 of the plurality of first signal terminals, but is not limited thereto. When the first connector 200 in which the set 260 of the plurality of first signal terminals and the set 270 of the plurality of second signal terminals are symmetrical to each other with respect to the wall 220, and the second connector 300 in which the set 360 of the plurality of third signal terminals and the set 370 of the plurality of fourth signal terminals are symmetrical to each other with respect to an accommodation space 311 are fastened, the set 360 of the plurality of third signal terminals may be in contact with the set 270 of the plurality of second signal terminals.

The signal terminal 370′ of the set 370 of the plurality of fourth signal terminals may cover the fourth partition wall 324. When the first connector 200 and the second connector 300 are combined, the signal terminal 370′ covering the fourth partition wall 324 may be in contact with the second movable part 273. Through the signal terminal 370′ in contact with the second movable part 273, the signal terminal 370′ of the set 370 of the plurality of fourth signal terminals may be electrically connected to the signal terminal 270′ of the set 270 of the plurality of second signal terminals. The signal terminal 370′ of the set 370 of the plurality of fourth signal terminals may press the signal terminal 270′ of the set 270 of the plurality of second signal terminals. The second movable part 273 of the pressed signal terminal 270′ of the set 270 of the plurality of second signal terminals may be deformed.

It is described that the signal terminal 370′ of the set 370 of the plurality of fourth signal terminals is in contact with the signal terminal 270′ of the set 270 of the plurality of second signal terminals, but is not limited thereto. When the first connector 200 in which the set 260 of the plurality of first signal terminals and the set 270 of the plurality of second signal terminals are symmetrical to each other with respect to the wall 220, and the second connector 300 in which the set 360 of the plurality of third signal terminals and the set 370 of the plurality of fourth signal terminals are symmetrical to each other with respect to the accommodation space 311 are fastened, the set 370 of the plurality of fourth signal terminals may be in contact with the set 260 of the plurality of first signal terminals.

The signal terminal 260′ configuring the set 260 of the plurality of first signal terminals and the signal terminal 270′ configuring the set 270 of the plurality of second signal terminals may be spirally wound to have elasticity for a connection between the first connector 200 and the second connector 300.

According to the above-described embodiment, the spirally wound set 260 of the plurality of first signal terminals and set 270 of the plurality of second signal terminals may be deformed by being pressed by fastening of the second connector 300. The deformed set 260 of the plurality of first signal terminals and set 270 of the plurality of second signal terminals may press the wall 220. A repulsive force caused from the wall 220 in accordance with the pressure of the wall 220 may be transmitted to a contact between the signal terminal 260′ and the signal terminal 360′ (or the signal terminal 370′) and a contact between the signal terminal 270′ and the signal terminal 370′ (or the signal terminal 360′). The connection between the first connector 200 and the second connector 300 may be maintained by the transmitted repulsive force.

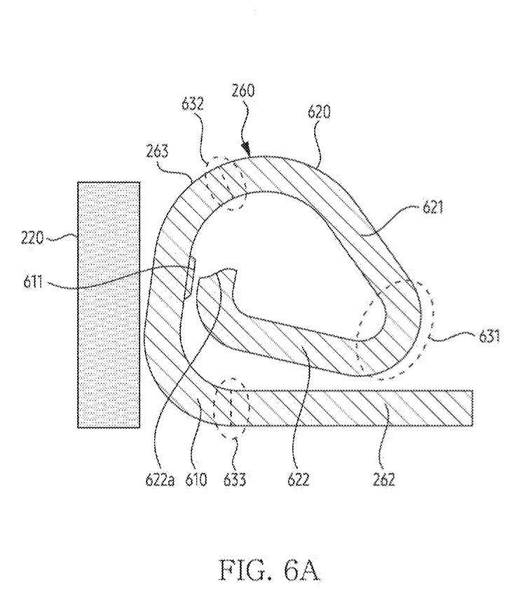

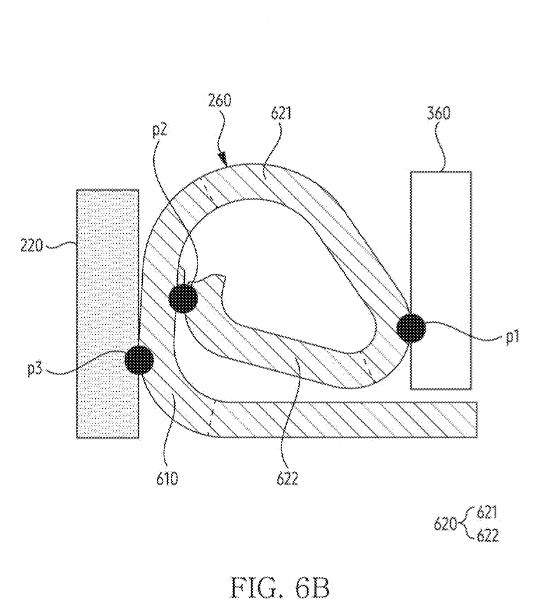

A shape of the signal terminals included in the above-described set 260 of the first signal terminals and set 270 of the second signal terminals will be described based on FIGS. 6A and 6B.

FIG. 6A is a diagram representing an example movable terminal of a first connector 200. FIG. 6B is a diagram representing a change in a movable terminal of a first connector 200 when a second connector 300 is combined with the first connector 200.

Referring to FIGS. 6A and 6B, when a width (or a pitch) of a terminal (e.g., a terminal of a set 260 of a plurality of first signal terminals) configuring a connector (e.g., the first connector 200) is narrowed, pressure between the terminal and another terminal (e.g., a terminal of a set 270 of a plurality of second signal terminals) configuring another connector (e.g., a second connector 300) may be lowered. In order to maintain a connection between the first connector 200 and the second connector 300, the first connector 200 according to an embodiment may include a structure for increasing pressure (e.g., contact pressure) between terminals.

Each signal terminal of the set 260 of the plurality of first signal terminals may include a first movable part 263 having a holding part 610 and a contact part 620. The holding part 610 may be connected to a first extension part 262. The holding part 610 may be extended along a wall 220. The contact part 620 may be pressed by a second connector (e.g., the second connector 300 of FIG. 1 and the second connector 300 of FIG. 3). For example, the contact part 620 may include a contact in contact with a signal terminal of a set 360 of a plurality of third signal terminals (or a set 370 of a plurality of fourth signal terminals) of the second connector 300. The signal terminal of the set 360 of the plurality of third signal terminals (or the set 370 of the plurality of fourth signal terminals) may be in contact with the contact part 620 in an area p1. For example, when the first connector 200 and the second connector 300 are combined, the signal terminal of the set 360 of the plurality of third signal terminals (or the set 370 of the plurality of fourth signal terminals) may press the contact part 620 in the area p1.

The holding part 610 may be configured to be contacted to the contact part 620 that is moved in accordance with the pressure of the second connector 300, when the first connector 200 is connected to the second connector 300. For example, when the first connector 200 is connected to the second connector 300, the contact part 620 in contact with the signal terminal of the set 360 of the plurality of third signal terminals may be moved toward the wall 220 or the holding part 610. The contact part 620 moved toward the holding part 610 may be in contact with an inner surface of the holding part 610. When the first connector 200 is connected to the second connector 300, the contact part 620 may be in contact with the holding part 610 in an area p2. The contact part 620 may press the area p2 of the holding part 610.

When the first connector 200 is connected to the second connector 300, the holding part 610 may be deformed to be contacted to the wall 220 by the pressure of the contact part 620. The holding part 610 may be configured to be deformed by contact with the contact part 620 to press the wall 220. A portion of the holding part 610 pressed by the contact part 620 may be moved toward the wall 220. The holding part 610 may press the wall 220 in an area p3.

The holding part 610 may be configured to maintain the connection between the first connector 200 and the second connector 300 by transmitting a repulsive force caused from the wall 220 to the contact part 620 in accordance with pressure of the wall 220. The repulsive force caused from the wall 220 in the area p3 may be transmitted to the holding part 610. The repulsive force transmitted to the area p3 may be transmitted to the contact part 620 in contact with the holding part 610 through the area p2. The repulsive force transmitted to the area p2 may be transmitted through the area p1 to a signal terminal of the set 360 of the plurality of third signal terminals (or the set 370 of the plurality of fourth signal terminals) in contact with the contact part 620. The repulsive force transmitted to the signal terminal of the signal terminal of the set 360 of the plurality of third signal terminals (or the set 370 of the plurality of fourth signal terminals) through the area p1 may maintain the connection between the first connector 200 and the second connector 300.

When the first connector 200 is disconnected from the second connector 300, the holding part 610 may be deformed to be spaced apart from the wall 220. When the first connector 200 is disconnected from the second connector 300, a connection between the set 360 of the plurality of third signal terminals (or the set 370 of the plurality of fourth signal terminals) and the set 260 of the plurality of first signal terminals may be disconnected. When the first connector 200 is disconnected from the second connector 300, the force applied to the contact part 620 may be removed by the signal terminal of the set 360 of the plurality of third signal terminals (or the set 370 of the plurality of fourth signal terminals) in the area p1. When the first connector 200 is disconnected from the second connector 300, the contact part 620 may be released from contact with the holding part 610. By removing the force applied from the signal terminal of the set 360 of the plurality of third signal terminals (or the set 370 of the plurality of fourth signal terminals) in the area p1, the contact part 620 may be spaced apart from the holding part 610 in the area p2. A portion of the holding part 610 from which the contact with the contact part 620 is released may be spaced apart from the wall 220 in the area p3.

The contact part 620 may further include an extension area 621 and a pressing area 622 to transmit a force applied from the second connector 300, when the first connector 200 is connected to the second connector 300. The extension area 621 may be connected to the holding part 610. A distance from a base (e.g., the base 210 of FIG. 2) to a connection point between the holding part 610 and the extension area 621 may be different from a distance between the area p1 and the base 210. The extension area 621 may be extended from the holding part 610 to the area p1. The extension area 621 may be inclined with respect to the base (or the first extension part 262). When the first connector 200 is fastened to the second connector 300, the area p1 may be in contact with a terminal included in the set 360 of the plurality of third signal terminals (or the set 370 of the plurality of fourth signal terminals) of the second connector 300. The area p1 may be referred to as a contact area in terms of being in contact with another terminal.

The pressing area 622 may be extended from the area p1 toward the holding part 610. When the first connector 200 is combined with the second connector 300, the pressing area 622 may press an inner surface of the holding part 610 facing the contact part 620. An end 622a of the pressing area 622 may face the inner surface of the holding part 610. When the first connector 200 is combined with the second connector 300, the end 622a of the pressing area 622 may be in contact with the inner surface of the holding part 610 due to deformation of the contact part 620. For example, a protruding part 611 (or an embossed area) may be formed on the inner surface of the holding part 610 in contact with the end 622a of the pressing area 622.

Each terminal configuring the set 260 of the plurality of first signal terminals may include a plurality of bending areas. For example, the first movable part 263 may include a first bending area 632 disposed between the holding part 610 and the contact part 620, and a second bending area 631 and a third bending area 633 to distribute stress applied to a bending area positioned between the contact part 620 and the holding part 610 when the first connector 200 is connected to the second connector 300. The second bending area 631 may be disposed in the contact part 620. For example, the second bending area 631 may be the same area as the area p1 or may be an area around the area p1. The third bending area 633 may be positioned between the first extension part 262 and the first movable part 263. The plurality of bending areas 631, 632, and 633 may provide deformation of a terminal configuring the set 260 of the plurality of first signal terminals. For example, while the set 260 of the plurality of first signal terminals is deformed, the first bending area 632 may include a rotation axis of the extension area 621. When the area p1 is pressed by the second connector 300, the extension area 621 may rotate counterclockwise around the first bending area 632. While the set 260 of the plurality of first signal terminals is deformed, the second bending area 631 may include a rotation axis of the pressing area 622. When the area p1 is pressed by the second connector 300, the pressing area 622 may rotate counterclockwise around the second bending area 631. While the set 260 of the plurality of first signal terminals is deformed, the third bending area 633 may include a rotation axis of the first movable part 263. When the area p1 is pressed by the second connector 300, the first movable part 263 may rotate clockwise around the third bending area 633.

It is described that the above-described embodiments are applied to the set 260 of the plurality of first signal terminals, but are not limited thereto, and in a case that the set 260 of the plurality of first signal terminals and the set 270 of the plurality of second signal terminals are symmetrical to each other with respect to the wall 220, and the set 360 of the plurality of third signal terminals and the set 370 of the plurality of fourth signal terminals are symmetrical to each other with respect to the accommodation space 311, it may be equally or similarly applied to the set 270 of the plurality of second signal terminals.

In order to increase pressure (e.g., contact pressure) between terminals, the first connector 200 according to the above-described embodiment may maintain the connection between the first connector 200 and the second connector 300 by including a plurality of bending areas and providing a plurality of contact points.

The first connector 200 configured to provide high pressure between terminals may form the terminals with a narrow width. A size of the first connector 200 forming the narrow width may be reduced. The small size first connector 200 may increase utilization of an internal space of an electronic device.

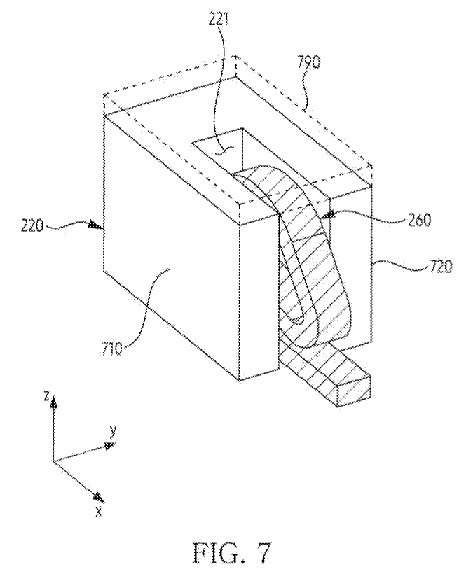

FIG. 7 is an enlarged view of an area C of a first connector 200.

Referring to FIG. 7, a wall 220 of the first connector 200 may include guide walls 710 and 720 disposed in both sides of a signal terminal of a set 260 of a plurality of first signal terminals. The guide walls 710 and 720 may include a first guide wall 710 disposed in a side of the signal terminal of the set 260 of the plurality of first signal terminals and a second guide wall 720 disposed in another side of the signal terminal of the set 260 of the plurality of first signal terminals. The first guide wall 710 may cover a portion of the side of the signal terminal of the set 260 of plurality of the first signal terminals. The second guide wall 720 may cover a portion of the another side of the signal terminal of the set 260 of the plurality of first signal terminals. The first guide wall 710 and the second guide wall 720 may overlap the set 260 of the plurality of first signal terminals when a surface of the guide walls 710 and 720 is viewed vertically.

The first guide wall 710 and the second guide wall 720 may guide movement of the signal terminal when the signal terminal is pressed by an external object. For example, when the first connector 200 is combined with the second connector 300 in a case of being pressed by a terminal of the second connector 300, the signal terminal of the set 260 of the plurality of first signal terminals of the first connector 200 may move toward an inner surface of the wall 220 along the guide walls 710 and 720. The first guide wall 710 and the second guide wall 720 may guide movement of the signal terminal when a force applied to the signal terminal by an external object is released. For example, when the first connector 200 is disconnected from the second connector 300, in a case that a terminal of the first connector 200 is spaced apart from a terminal of the second connector 300, the signal terminal of the set 260 of the plurality of first signal terminals of the first connector 200 may be moved from the inner surface of the wall 220 to the outside (e.g., a side wall 231, 232, 233, or 234 of the first connector 200) of the wall 220 along the guide walls 710 and 720.

The wall 220 may include a cover 790 overlapping the set 260 of the plurality of first signal terminals. The wall 220 may include the cover 790 overlapping a portion of a contact part (e.g., the first contact part 244 of FIG. 2) of the set 260 of the plurality of first signal terminals, when the first connector 200 is viewed from above in a third direction (e.g., a -z-axis direction). The cover 790 may limit a terminal from being moved to an upper portion of the wall 220 when the signal terminal of the set 260 of the plurality of first signal terminals is moved to an internal space of the wall 220.

The above-described guide walls 710 and 720 have been described for a signal terminal of the set 260 of the plurality of first signal terminals, but it may be applied to all of the set 260 of the plurality of first signal terminals. For example, a plurality of guide walls may be respectively disposed between terminals configuring the set 260 of the plurality of first signal terminals.

It is described that the above-described guide walls 710 and 720 are applied to the set 260 of the plurality of first signal terminals, but are not limited thereto, and since the set 260 of the plurality of first signal terminals and a set 270 of a plurality of second signal terminals are symmetrical to each other with respect to the wall 220, it may be equally or similarly applied to the set 270 of the plurality of second signal terminals.

According to the above-described embodiment, terminals of the first connector 200 formed with a narrow width, may be deformed by a force applied from the outside. Since the terminal with the narrow width may have non-uniform movement of the terminal due to the deformation, the first guide wall 710 and the second guide wall 720 may guide the terminal to move to a designated path.

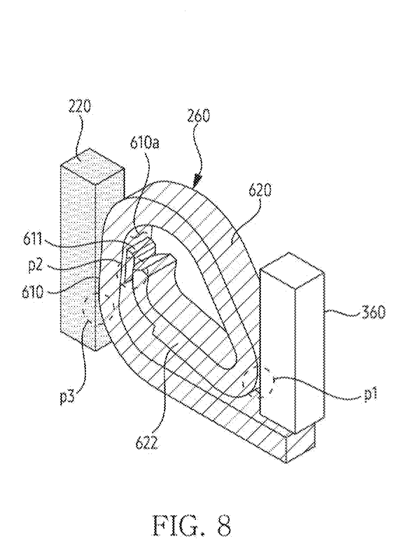

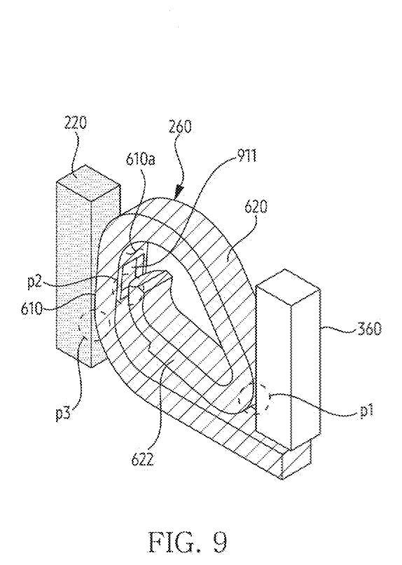

FIG. 8 is a diagram illustrating a movable terminal of a first connector 200 including a protruding part therein. FIG. 9 is a diagram illustrating a movable terminal of a first connector 200 including a groove therein.

Referring to FIGS. 8 and 9, when a contact part 620 is pressed in an area p1 by a signal terminal of a set 360 of a plurality of third signal terminals (or a set 370 of a plurality of fourth signal terminals), the contact part 620 may be deformed. For example, when the contact part 620 is pressed in the area p1 by the signal terminal of the set 360 of the plurality of third signal terminals (or the 370 of the plurality of the fourth signal terminals), a pressing area 622 of the contact part 620 may move toward an inner surface 610a of a holding part 610. By the movement of the pressing area 622, an end portion of the pressing area 622 may be in contact with a structure formed on the inner surface 610a of the holding part 610. The structure may be formed in an area p2. According to a shape of the structure, an amount of deformation of the contact part 620 of a set 260 of a plurality of first signal terminals may be determined.

The contact part 620 may include a groove for accommodating a portion of a terminal (e.g., a terminal of the set 360 of the plurality of third signal terminals or the set 370 of the plurality of fourth signal terminals) of a second connector 300 when a first connector 200 is combined with the second connector 300. The contact part 620 may include a groove formed in the area p1. However, embodiments are not limited thereto, and the contact part 620 may include a protrusion formed in the area p1. The protrusion formed in the area p1 may be inserted into a groove formed in a signal terminal of the set 360 of the plurality of third signal terminals.

Referring to FIG. 8, the holding part 610 may include a protruding part 611 (or an embossed area) that is in contact with the contact part 620, when the first connector 200 is connected to the second connector 300. A moving distance of the pressing area 622 may be reduced by a protruding distance of the protruding part 611 protruding from the surface 610a of the holding part 610.

As the moving distance of the pressing area 622 is reduced, a repulsive force caused by a wall 220 may be increased. With the increased repulsive force, contact pressure or a coupling force between terminals of the first connector 200 and terminals of the second connector 300 may be increased.

Referring to FIG. 9, the holding part 610 may include a groove 911 in contact with the contact part 620, when the first connector 200 is connected to the second connector 300. The moving distance of the pressing area 622 may increase by a depth of the groove 911 recessed from the surface 610a of the holding part 610. By providing the groove 911 by the moving distance of the pressing area 622, a size of the connector may be reduced.

It is described that the above-described embodiments are applied to the set 260 of the plurality of first signal terminals, but are not limited thereto, and in a case that the set 260 of the plurality of first signal terminals and the set 270 of the plurality of second signal terminals are symmetrical to each other with respect to the wall 220, and the set 360 of the plurality of third signal terminals and the set 370 of the plurality of fourth signal terminals are symmetrical to each other with respect to an accommodation space 311, it may also be applied to the set 270 of the plurality of second signal terminals.

A pair of connectors may include terminals with a narrow width for miniaturization of the connector. In order to increase contact pressure of the terminals with the narrow width and distribute stress of the terminal, each terminal may include a plurality of contact points and a plurality of bending parts. A connector and a board including the connector according to an embodiment may secure stability of a connection between the connectors and increase rigidity of the connector.

The technical problems to be achieved in the present disclsoure are not limited to those described above, and other technical problems not mentioned herein will be clearly understood by those having ordinary knowledge in the art to which the present disclosure belongs.

A connector (the first connector 200 of FIG. 1 or the first connector 200 of FIG. 2) according to the above-described embodiment may include a base (e.g., the base 210 of FIG. 2), a wall (e.g., the wall 220 of FIG. 2), and a terminal (e.g., the signal terminal of the set 260 of the plurality of first signal terminals of FIG. 2 or the signal terminal of the set 270 of the plurality of second signal terminals of FIG. 2). The wall 220 may be fixed to the base 210. The terminal 260 or 270 may be partially fixed to the base 210. The terminal 260 or 270 may be configured to be electrically connected to another connector (e.g., the second connector 300 of FIG. 1).

The terminal 260 or 270 may include a contact part (e.g., the contact part 620 of FIG. 6A) and a holding part (e.g., the holding part 610 of FIG. 6A). The contact part may be pressed by another connector 300. The holding part may be extended from the contact part 620. The holding part 610 may be, while the connector 200 is connected to the another connector 300, contacted with the contact part 620 that is moved in accordance with the pressure of the another connector 300. The holding part 610 may be deformed by the contact part 620 to press the wall 220. The holding part 610 may be configured to maintain a connection between the connector 200 and the another connector 300, by a repulsive force caused from the wall 220 in accordance with the pressure of the wall 220.

The first connector 200 according to the above-described embodiment may increase contact pressure for maintaining a connection with the second connector 300. By the repulsive force caused by the contact part 620 of the first connector 200 pressing the wall 220, pressure of a contact portion between the first connector 200 and the second connector 300 may be increased. Based on the increased pressure between the first connector 200 and the second connector 300, a connection of a pair of connectors having a small size may be maintained. The first connector and the second connector may improve space efficiency of an electronic device including a plurality of components.

The contact part 620 may include an extension area (e.g., the extension area 621 of FIG. 6A), a contact area (e.g., the area p1), and a pressing area (e.g., the pressing area 622 of FIG. 6A). The extension area 621 may be extended from the holding part 610. The contact area p1 connected to the extension area 621 may be electrically connected to another terminal 360 or 370 of the another connector 300, when the connector 200 is connected to the another connector 300. The pressing area 622 extended from the contact area p1 to the holding part 610 may press a surface of the holding part 610 toward the contact part 620, when the connector 200 is connected to the another connector 300.

The first connector 200 according to the above-described embodiment may cause a repulsive force of the wall 220 by having a plurality of contact areas, and may increase contact pressure with the second connector 300.

When the connector 200 is connected to the another connector 300, a portion of the holding part 610 may be deformed to face the wall 220 by the pressure of the contact part 620.

The holding part 610 may be deformed to move away from the wall 220, when the connector 200 is disconnected from the another connector 300.

The holding part 610 according to the above-described embodiment may stably provide connection and release between connectors by having elasticity.

The terminal 260 or 270 may be spirally wound to have elasticity for the connection between the connector 200 and the another connector 300.

The spiral terminal according to the above-described embodiment may improve an elastic force by having a plurality of contacts.

The terminal 260 or 270 may include a first bending area (e.g., the first bending area 632 of FIG. 6A) and a second bending area (e.g., the second bending area 631 of FIG. 6A). The first bending area 632 may be disposed between the contact part 620 and the holding part 610.

The second bending area 631 may be disposed within the contact part 620 to distribute stress applied to the bending area positioned between the contact part 620 and the holding part 610, when the connector 200 is connected to the another connector 300.

The connector according to the above-described embodiment may reduce concentration of stress applied to a point of a terminal by including terminals including bending areas. By distributing the stress, it may reduce destruction of the terminal. By reducing damage to the terminal, it may reduce a failure of the electronic device due to damage to the connector.

The wall 220 may include a first guide wall 710 covering a side of the terminal 260 or 270 and a second guide wall 720 covering another side of the terminal 260 or 270. The guide walls 710 and 720 may guide the movement of the contact part 620 in a direction toward the wall 220.

The holding part 610 may include a protruding part (e.g., the protruding part 611 of FIG. 6A). The protruding part 611 may be configured to be contacted to the contact part 620, when the connector 200 is connected to the another connector 300.

The holding part 610 may include a groove (e.g., the groove 911 of FIG. 9). The groove 911 may be contacted to the contact part 620, when the connector 200 is connected to the another connector 300.

The connector according to the above-described embodiment may adjust an amount of movement (or an amount of overlapping) of the terminal according to contact, by using a structure (a groove or a protruding part) formed in the holding part 610.

The wall 220 may include a cover (e.g., the cover 790 of FIG. 7). The cover 790 may overlap a portion of the contact part 620, when the connector 200 is viewed from above.

The connector according to the above-described embodiment may limit a position of the terminal by including the cover covering a portion of the terminal. The connector including the cover may position a terminal having a relatively thin width within a space formed in the wall.

A width of the terminal 260 or 270 may be 0.15 mm to 0.3 mm.

The contact part 620 may include a terminal groove accommodating a portion of the terminal 260 or 270 of the another connector 300 when combined with the another connector 300.

The connector according to the above-described embodiment may maintain the connection between the connector and the another connector when fastened to the another connector, by including the terminal groove.

The connector 200 may further include another terminal 270 or 260 that is linearly symmetrical to the terminal 260 or 270 with respect to the wall 220.

The connector 200 may further include a first terminal set including a plurality of terminals 260 or 270 spaced apart from the terminal 260 or 270 at designated intervals along the wall 220, and a second terminal set including a plurality of terminals 260 or 270 spaced apart from the another terminal 270 or 260 at designated intervals along the wall 220.

The connector 200 may further include a side wall 231, 232, 233, or 234 spaced apart from the wall 220 and the terminal 260 or 270 and formed along a periphery of the base 210.

The base 210 and the wall 220 may include a non-conductive material. The terminal 260 or 270 may include a conductive material.

A printed circuit board (e.g., the printed circuit board 10 of FIG. 1) may include a substrate, and a connector 200 mounted on the substrate, the connector 200 including a fixed wall 220 and a movable terminal 260 or 270 having elasticity.

The movable terminal 260 or 270 may include a contact part 620 in contact with a terminal 360 or 370 of another connector 300, and a holding part 610, connected to the contact part 620, extended toward the substrate along the wall 220.

The contact part 620 may include an extension area 621 connected to the holding part 610. The contact part 620 may include a contact area p1 connected to the extension area 621 and moving toward the wall 220 in contact with a terminal 260 or 270 of the another connector 300. The contact part 620 may include a pressing area 622 extended from the contact area p1 to the holding part 610, the pressing area 622 that contacts a surface of the holding part 610 facing the contact part 620 as the contact area p1 moves.

The holding part 610 may be configured to be deformed by the contact with the contact part 620 to press the wall 220 and maintain a connection between the connector 200 and the another connector 300 by transmitting, to the contact part 620, a repulsive force caused from the wall 220 in accordance with the pressure of the wall 220.

The movable terminal 260 or 270 may include a first bending area 632 positioned between the contact part 620 and the holding part 610. The movable terminal 260 or 270 may further include a second bending area 631 positioned between the contact area p1 and the pressing area 622.

A portion of the holding part 610 may be deformed to be contacted to the wall 220 by the pressure of the contact part 620, when the connector 200 is connected to the another connector 300.

The holding part 610 may be deformed to be spaced apart from the wall 220, when the connector 200 is disconnected from the another connector 300.

The wall 220 may guide the movement of the contact part 620 in a direction toward the wall 220 by including a first guide wall 710 covering a side of the terminal 260 or 270 and a second guide wall 720 covering another side of the terminal 260 or 270.

A width of the terminal 260 or 270 may be 0.15 mm to 0.3 mm.

The effects that can be obtained from the present disclosure are not limited to those described above, and any other effects not mentioned herein will be clearly understood by those having ordinary knowledge in the art to which the present disclosure belongs, from the following description.

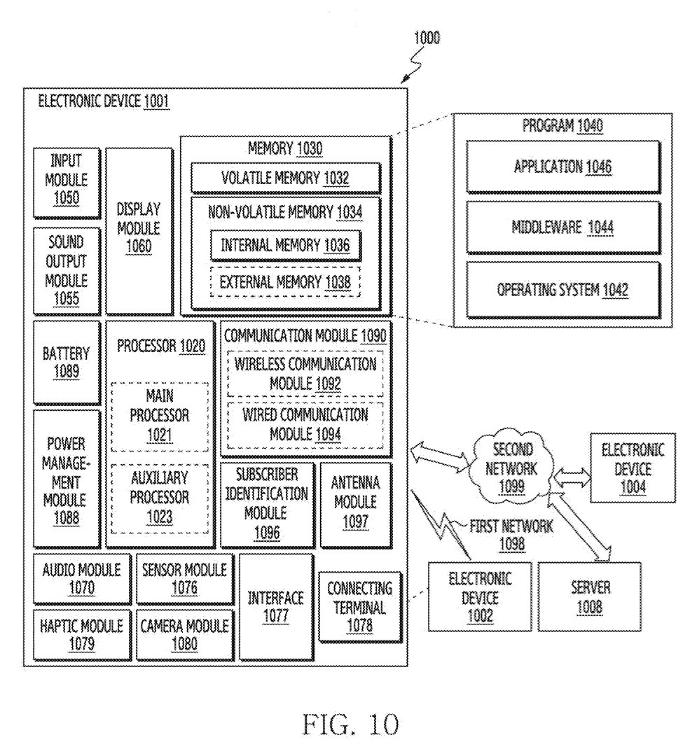

FIG. 10 is a block diagram illustrating an electronic device 1001 in a network environment 1000 according to various embodiments.

Referring to FIG. 10, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module(SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20Gbps or more) for implementing eMBB, loss coverage (e.g., 1064dB or less) for implementing mMTC, or U-plane latency (e.g., 0.5ms or less for each of downlink (DL) and uplink (UL), or a round trip of 10ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A connector comprising:
a wall; and
a terminal spaced apart from the wall and configured to be electrically connected to another connector,
wherein the terminal comprises:
a contact part configured to be pressed by the another connector, in a state that the connector is connected to the another connector; and
a holding part extended from the contact part, and
wherein the holding part is, while the connector is connected to the another connector, configured to:
be contacted with the contact part that is moved in accordance with a pressure exerted by the another connector,
be deformed by the contact with the contact part to press the wall, and
maintain a connection between the connector and the another connector by transmitting, to the contact part, a repulsive force caused by pressing the wall.

2. The connector of claim 1, wherein the contact part comprises:
an extension area connected to the holding part;
a contact area connected to the extension area, the contact area being in contact with another terminal of the another connector, in the state that the connector is connected to the another connector; and
a pressing area extended from the contact area to the holding part, the pressing area pressing a surface of the holding part toward the contact part, in the state that the connector is connected to the another connector.

3. The connector of claim 2, wherein the holding part is configured to be deformed to be spaced apart from the wall, in a state that the connector is disconnected from the another connector.

4. The connector of claim 3, wherein the terminal is spirally wound to have elasticity for the connection between the connector and the another connector.

5. The connector of claim 4, wherein the terminal further comprises:
a first bending area positioned between the contact part and the holding part; and
a second bending area positioned within the contact part and configured to distribute stress applied to the terminal, in the state that the connector is connected to the another connector.

6. The connector of claim 5, wherein the wall comprises a first guide wall covering a side of the terminal and a second guide wall covering another side of the terminal, and
wherein the first guide wall and the second guide wall are configured to guide movement of the contact part in a direction toward the wall.

7. The connector of claim 6, wherein the holding part comprises a protruding part contacting the contact part, in the state that the connector is connected to the another connector.

8. The connector of claim 6, wherein the holding part comprises a groove contacting the contact part, in the state that the connector is connected to the another connector.

9. The connector of claim 8, wherein the wall comprises a cover overlapping a portion of the contact part, when the connector is viewed from above.

10. The connector of claim 9, wherein a width of the terminal is 0.15 mm to 0.3 mm.

11. The connector of claim 10, wherein the contact part comprises a fastening groove configured to accommodate a portion of a terminal of the another connector in the state that the connector is connected to the another connector.

12. The connector of claim 11, further comprising another terminal that is linearly symmetrical to the terminal with respect to the wall.

13. The connector of claim 12, further comprising:
a first terminal set comprising a plurality of terminals spaced apart from the terminal at designated intervals along the wall; and
a second terminal set comprising a plurality of terminals spaced apart from the another terminal at designated intervals along the wall.

14. The connector of claim 13, further comprising:
a base supporting the wall; and
a side wall spaced apart from the wall and the terminal and disposed along a periphery of the base.

15. The connector of claim 14, wherein the wall comprises a non-conductive material, and
wherein the terminal comprises a conductive material.

16. A printed circuit board comprising:
a substrate; and
a connector mounted on the substrate, the connector comprising a fixed wall and a movable terminal having elasticity;
wherein the movable terminal comprises:
a contact part configured to contact a terminal of another connector, in a state that the connector is connected to the another connector, and
a holding part extended from the contact part toward the substrate along the wall,
wherein the contact part comprises:
an extension area connected to the holding part,
a contact area connected to the extension area and configured to move toward the wall in contact with another terminal of the another connector, while the connector is connected to the another connector, and
a pressing area extended from the contact area to the holding part, the pressing area contacting a surface of the holding part facing the contact part as the contact area moves, and
wherein the holding part is configured to, while the connector is connected to the another connector, be deformed by the contact with the contact part to press the wall and maintain a connection between the connector and the another connector by transmitting, to the contact part, a repulsive force caused by pressing the wall.

17. The printed circuit board of claim 16, wherein the movable terminal comprises:
a first bending area positioned between the contact part and the holding part; and
a second bending area positioned between the pressing area and the contact area.

18. The printed circuit board of claim 17, wherein the holding part is configured to be deformed to be spaced apart from the wall, in a state that the connector is disconnected from the another connector.

19. The printed circuit board of claim 18, wherein the wall comprises a first guide wall covering a side of the terminal and a second guide wall covering another side of the terminal, and
wherein the first guide wall and the second guide wall are configured to guide movement of the contact part in a direction toward the wall.

20. The printed circuit board of claim 19, wherein a width of the terminal is 0.15 mm to 0.3 mm.
